(19) United States
(12) Patent Application Publication
(10) Pub. No.: US 2008/0281919 A1
(43) Pub. Date: Nov. 13, 2008

(54) System and Method for Sharing Images

(75) Inventors: Scott A. Shamp, Athens, GA (US); Matt Griffin, Buford, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: University of Georgia Research Foundation, Inc., Athens, GA (US)

(21) Appl. No.: 12/118,631

(22) Filed: May 9, 2008

Related U.S. Application Data
(60) Provisional application No. 60/916,952, filed on May 9, 2007.

(51) Int. Cl. G06F 3/14; G06F 15/16

(52) U.S. Cl. 709/205; 715/273

(57) ABSTRACT

In one embodiment, a system and a method for sharing images relate to receiving images transmitted via the Internet and intended for viewing by a particular intended recipient, automatically storing the images in association with the intended recipient, detecting physical proximity of the intended recipient to a display device, and responsive to the detecting, displaying the images on the display device for the intended recipient.

### CROSS-REFERENCE TO RELATED APPLICATION

This application claims priority to copending U.S. provisional application entitled, “Systems and Method for Sharing Images,” having Ser. No. 60/916,952, filed May 9, 2007, which is entirely incorporated herein by reference.

### BACKGROUND

The advent of the Internet has greatly improved the ease with which people can share information. However, not everyone has taken advantage of the information-sharing capabilities that the Internet provides. For example, persons of older generations may not be technologically savvy and may be uncomfortable with using computers. As a result, they may not know how to use the Internet and therefore cannot send or receive such information.

The inability of such persons to use the Internet is unfortunate given that the Internet could be used to provide those persons with information they really wish to receive, such as photographs of their children and grandchildren. Given the present transition from film and hard copy photographs to digital media, persons that do not use the Internet may miss opportunities to enjoy photographs that they might otherwise receive. Although such persons could be taught how to use a computer and the Internet, those persons may be reluctant to try, either due to embarrassment about their relative ignorance or doubts about their ability to learn an unfamiliar technology.

In view of the above, it would be desirable to have a system and method with which photographic images can be shared with persons via the Internet without requiring those persons to operate a computer.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system with which images can be shared.

FIG. 2 is a block diagram of an embodiment of a server computer shown in FIG. 1.

FIG. 3 is a block diagram of an embodiment of a display device shown in FIG. 1.

FIG. 4 is a flow diagram that illustrates an embodiment of a method for sharing images.

FIG. 5 is a flow diagram that illustrates an embodiment of operation of an image management program of the server computer of FIG. 2.

FIG. 6 is a flow diagram that illustrates a first embodiment of operation of a display management program of the display device of FIG. 3.

FIG. 7 is a flow diagram that illustrates a second embodiment of operation of the display management program of the display device of FIG. 3.

### DETAILED DESCRIPTION

As described above, it would be desirable to have a system and method with which photographic images can be shared with persons via the Internet without requiring those persons to operate a computer. Described herein are examples of such systems and methods. In one embodiment, a system comprises a computer that receives images that were transmitted via the Internet and provides the images to a shared display device, such as a digital picture frame device. When an intended recipient of the images communicates his or her presence to the display device, the display device displays the images for the recipient. In some embodiments, the intended recipient communicates his or her physical proximity using a radio frequency identification (RFID) tag that is read by the display device.

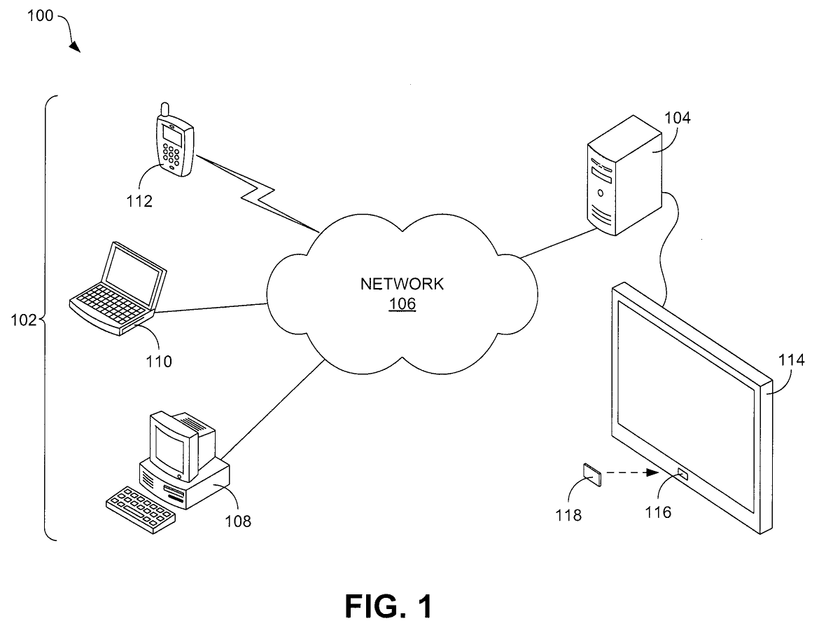

Referring to the drawings, in which like numerals identify corresponding parts throughout the several views, FIG. 1 illustrates an example system 100 that can be used to share images. As indicated in FIG. 1, the system 100 generally comprises image sources 102 that can communicate with a server computer 104 over a network 106, such as the Internet. In the illustrative embodiment of FIG. 1, the image sources 102 comprise a desktop computer 108, a laptop computer 110, and a mobile telephone or personal digital assistant (PDA) 112. Each of those sources 102 is capable of sending (transmitting) photographic image data in the form of one or more image files to the server computer 104. By way of example, the data can be sent as attachments to email messages or multi-media messaging service (MMS) messages.

With further reference to FIG. 1, the system 100 also comprises a display device 114 that is placed in communication with the server computer 104. By way of example, the display device 114 is a shared digital picture frame device located in a public area at which several persons can access the display device. For instance, the display device 114 can be placed in a common area (e.g., recreation room or media room) of an assisted living facility. In some embodiments, the display device 114 is directly connected to the server computer 104 either with a wired or wireless connection. In other embodiments, the display device 114 is indirectly connected to the server computer 104 with a network, such as a local area network (LAN) or the Internet. In still other embodiments, the display device 114 and the server computer 104 are combined into a single integrated device. When server computer 104 and the display device 114 are separate devices, the server computer can send (transmit) photographic image data to the display device for storage and display. As is also shown in FIG. 1, the display device 114 comprises an identification device reader 116 that is used to read identification devices of intended recipients of the images sent to the server computer 104, also referred to herein as “users” of the display device. An example identification device 118 is shown in FIG. 1 in the form of an identification card.

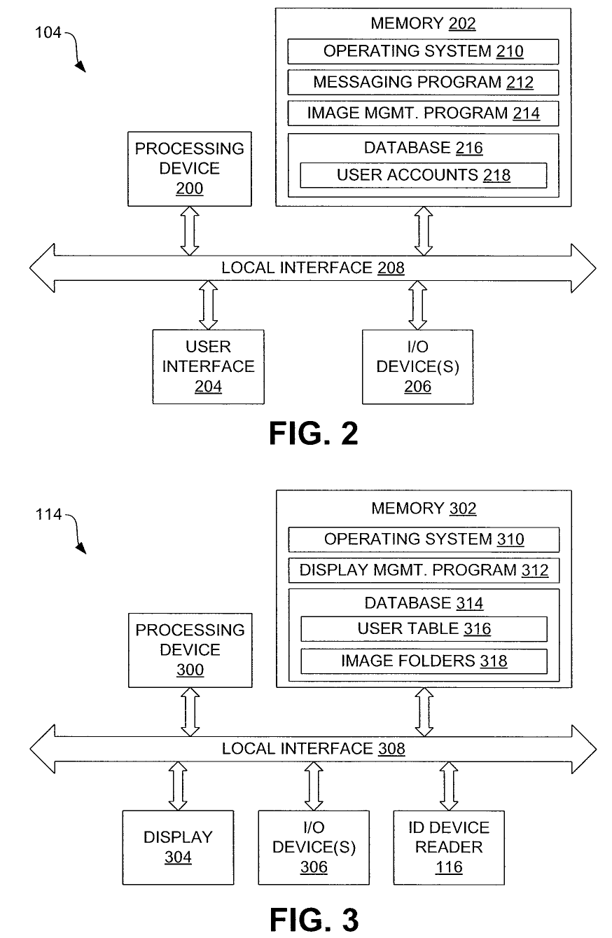

FIG. 2 is a block diagram illustrating an example architecture for the server computer 104. In the embodiment of FIG. 2, the server computer 104 comprises a processing device 200, memory 202, a user interface 204, and at least one I/O device 206, each of which is connected to a local interface 208.

The processing device 200 can comprise a central processing unit (CPU) or a semiconductor-based microprocessor that executes stored commands. The memory 202 includes any one of or a combination of volatile memory elements (e.g., RAM) and nonvolatile memory elements (e.g., hard disk, ROM, tape, etc.).

The user interface 204 comprises the components with which an operator (e.g., system administrator) interacts with the computer 104. The user interface 204 may comprise, for example, a keyboard, mouse, and a display, such as a liquid crystal display (LCD). The one or more I/O devices 206 are adapted to facilitate communications with other devices, such as the image sources 102 and the display device 114, and may include one or more communication components, such as a modulator/demodulator (e.g., modem), a wireless device (e.g., RF transceiver), a network card, and the like.

The memory 202 comprises various programs (i.e., logic) including an operating system 210, a messaging program 212, and an image management program 214. The operating system 210 controls the execution of other programs and provides scheduling, input-output control, file and data management, memory management, and communication control and related services. The messaging program 212 is used to receive messages, such as email and MMS messages, that are sent to the server computer 104 via the network 106. The image management program 214 is configured to strip image files from the received messages to enable the provision of image files to the display device 114. In some embodiments, the image management program 214 is configured to modify the images for optimal display on the display device 114. In addition, the image management program 214 can store copies of the original and/or modified image files in a database 216 under particular user accounts 218 associated with particular intended recipients. By way of example, the user accounts 218 comprise a separate folder for each intended recipient.

FIG. 3 is a block diagram illustrating an example architecture for the display device 114 shown in FIG. 1. As indicated in FIG. 3, the display device 114 may comprise many of the same components as the server computer 104 of FIG. 2. Indeed, in some embodiments, the display device 114 may comprise its own computer, whether separate from or integrated with the display device. Regardless, in the embodiment of FIG. 3, the display device 114 also includes a processing device 300, memory 302, a display 304, and at least one I/O device 306, each of which has the same or similar construction and/or function of like-named components described above in relation to FIG. 2. In addition, however, the display device 114 further includes the identification device reader 116 first identified in FIG. 1.

As indicated in FIG. 3, the memory 302 comprises an operating system 310 that controls the basic operation of the display device 114, and a display management program 312 that controls the storage and display of images relative to intended recipients. The memory 302 further comprises a database 314 that includes a user table 316 and image folders 318. The user table 316 cross-references user identification codes with registered users (i.e., intended recipients of images) and can therefore be used to determine which images to display as to each user. In some embodiments, the associated image files can be stored in the image folders 318, with each folder being associated with a single user.

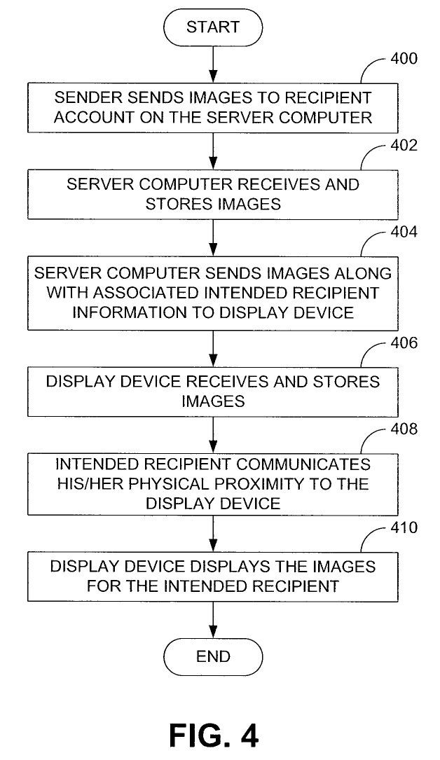

FIG. 4 illustrates an example method for sharing images using the system 100 of FIG. 1. Beginning with block 400 of FIG. 4, a sender sends images to a recipient account on the server computer 104. By way of example, the sender transmits images attached to an email or MMS message from one of the image sources 102 over the network 106 to a messaging account associated with the messaging program 212 that resides on the server computer 104. In some embodiments, the message can be sent to a dedicated email or MMS account solely used for the reception of images that are to be shared with an intended recipient.

As indicated in block 402, the server computer 104 receives and stores the images and, as indicated in block 404, sends the images along with associated intended recipient information to the display device 114. In some embodiments, the information comprises information that is individually associated with each image, such as a meta-data tag applied to each image. In other embodiments, the information comprises an identifier associated with a group of images, such as an identifier contained in a data packet that precedes data packets that contain the various image data. In either case, the information conveys to the display device 114 the intended recipient to whom to the images belong.

Referring next to block 406, the display device 114 receives and stores the images. At that point, the display device 114 is prepared to display images for intended recipients. Therefore, once an intended recipient communicates his or her physical proximity to the display device 114, as indicated in block 408, the display device displays the images for the intended recipient, as indicated in block 410. As mentioned above, the intended recipient can communicate his or her physical proximity using an identification device that is read by an identification device reader 116 of the display device 114. By way of example, the identification device comprises an identification card or an article that the intended recipient can wear, such as a bracelet. In some embodiments, the identification device 118 comprises an RFID tag that stores a user identification code that is read by an RFID tag reader of the display device 114 when the RFID tag is placed near (e.g., within a few inches or feet) of the RFID tag reader. For instance, the RFID tag can be read when the intended recipient “swipes” his or her identification device across the RFID tag reader.

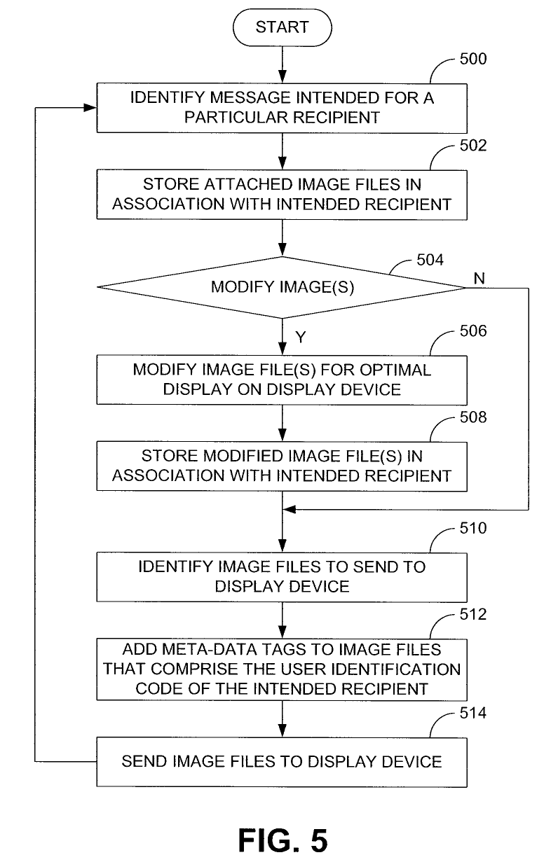

FIG. 5 illustrates an example of operation of the image management program 212 of the server computer 104. Beginning with block 500 of that figure, the image management program 212 identifies a message intended for a particular recipient once the message is received by the server computer 104. The image management program 212 identifies the image files attached to the message and, as indicated in block 502, automatically stores the attached image files in association with the intended recipient. In some embodiments, the image management program 212 stores the images in a folder of the user account 218 established for the intended recipient.

At this point, it can be determined whether to modify the images, as indicated in block 504. By way of example, such modification may be desirable when the aspect ratio or color gamut of the images do not match those of the display device 114. In some embodiments, such modification is optional and therefore can be selected or deselected by the system administrator. If no modification is to be performed, flow continues down to block 510 described below. If modification is to be performed, however, flow continues to block 506 at which one or more of the image files are modified for optimal display on the display device 114, and to block 508 at which the modified image files are automatically stored in association with the intended recipient. In some embodiments, the modified image files can be stored separately from the original image files. In such a case, each user account 218 can comprise an original image file folder and a modified image file folder so that the original images are preserved.

Next, the image management program 212 automatically identifies image files to send to the display device 114. In cases in which modified image files were created, those image files are selected for transmission to the display device 114 in lieu of the original image files, otherwise the original image files are selected. Prior to sending the identified image files to the display device 114, the image management program 212 automatically adds meta-data tags to each image file that comprise the user identification code of the intended recipient, as indicated in block 512. Finally, with regard to block 514, the image management program 212 automatically sends the image files to the display device 114. At that point, flow can return to block 500 and the process can be repeated for a new message that is received by the server computer 104.

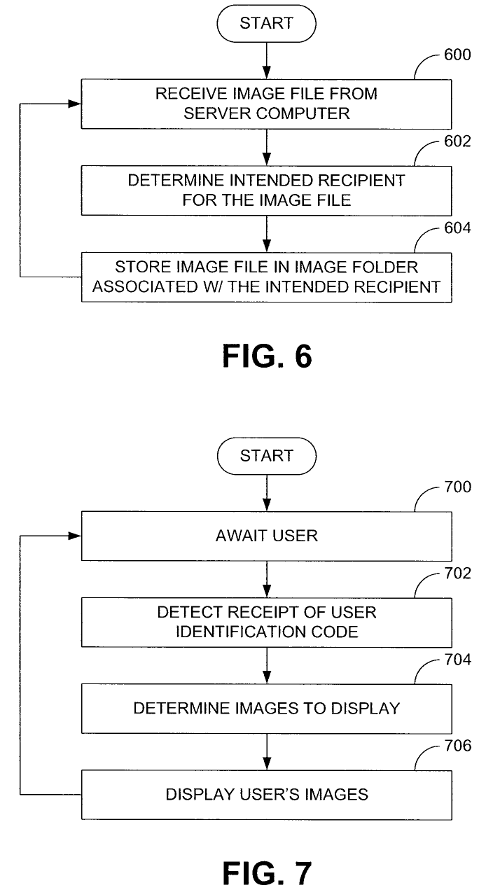

FIG. 6 illustrates a first example of operation of the display management program 312 of the display device 114. More particularly, FIG. 6 illustrates operation of the display management program 312 in storing received images for later display. Beginning with block 600 of that figure, the display management program 312 receives an image file from the server computer 104. The display management program 312 then determines the intended recipient of the image file, as indicated in block 602. By way of example, the display management program 312 makes that determination in light of the meta-data tag applied to the image file, which comprises the user identification code. Once the intended recipient is identified, the display management program 312 automatically stores the image file in a folder associated with the intended recipient, as indicated in block 604.

FIG. 7 illustrates a second example of operation of the display management program 312 of the display device 114. More particularly, FIG. 7 illustrates operation of the display management program 312 in displaying images to an intended recipient or user. Beginning with block 700, the display management program 312 awaits a user. Next, as indicated in block 702, the display management program 312 detects the receipt of a user identification code. By way of example, such detection occurs in response to the user swiping his or her identification device across the identification device reader 116.

Once the user identification code is detected, the display management program 312 determines the images to display, as indicated in block 704. By way of example, that determination is made by performing a look-up process in the user table 316. In particular, the user identification code is used to identify the image folder 318 associated with that user identification code and, therefore, the intended recipient of the images. Once that identification is made, the display management program 312 can display the user's images, as indicated in block 706. By way of example, the various images in the user's image folder 318 are sequentially displayed to the user as a slideshow.

As can be appreciated from the above, an intended recipient user can easily access and view images that have been sent to him or her via the Internet by simply positioning an identification device near a reader of the display device 114. Therefore, such a user can utilize the information-sharing capabilities of the Internet without even knowing how to operate a computer.

It is noted that various protocols can be used to update the images that are to be presented to the intended recipients. For example, in some embodiments, images can be maintained within the image folders 318 of the display device 114 for only a limited period of time, such as several weeks, such that only newer images will be presented to the user. In other embodiments, images can be maintained within the image folders until new images are received. In still other embodiments, the number of images that the image folders can hold can be limited and older images can be removed from the folders on a first-in, first-out basis. In any such case, however, the original image files will still be stored by the server computer 108 and, therefore, are preserved for the intended recipient should he or she wish to see it or have a hard copy made.

Various programs (logic) have been described herein. It is noted that those programs can be stored on any computer-readable medium for use by or in connection with any computer-related system or method. In the context of this document, a “computer-readable medium” is an electronic, magnetic, optical, or other physical device or means that contains or stores a computer program for use by or in connection with a computer-related system or method. Those programs can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

The following are claimed:

1. A method for sharing images, the method comprising:
receiving images transmitted via the Internet and intended for viewing by a particular intended recipient;
automatically storing the images in association with the intended recipient;
detecting physical proximity of the intended recipient to a display device; and
responsive to the detecting, displaying the images on the display device for the intended recipient.

2. The method of claim 1, wherein receiving images comprises a server computer receiving a message to which image files are attached, the message being directed to an account of the intended recipient.

3. The method of claim 2, further comprising stripping the image files from the message.

4. The method of claim 3, wherein automatically storing the images comprises automatically storing the image files on the server computer in association with the intended recipient.

5. The method of claim 4, further comprising sending the image files along with associated intended recipient information to the display device.

6. The method of claim 1, wherein automatically storing the images comprises automatically storing the images on the display device in an image folder associated with the intended recipient.

7. The method of claim 1, wherein detecting physical proximity of the intended recipient comprises the display device detecting physical proximity of an identification device of the intended recipient.

8. The method of claim 7, wherein detecting physical proximity of an identification device comprises reading a user identification code stored by the identification device.

9. The method of claim 8, wherein the user identification code is stored in a radio-frequency identification (RFID) tag of the identification device, and wherein reading the user identification code comprises reading the user identification code with an RFID tag reader of the display device.

10. A system for sharing images, the system comprising:
a computer configured to receive images transmitted over the Internet and intended for viewing by a particular intended recipient and to automatically send the images along with associated intended recipient information to a display device;
a display device configured to receive the images sent by the computer, to automatically store the images in association with the intended recipient, to detect the physical proximity of the intended recipient, and, responsive to the detecting, display the images.

11. The system of claim 10, wherein the computer is configured to receive image files attached to a message directed to an account of the intended recipient.

12. The system of claim 11, wherein the computer is further configured to strip the image files from the message and automatically store the image files on the server computer in association with the intended recipient.

13. The system of claim 10, wherein the associated intended recipient information comprises a user identification code.

14. The system of claim 13, wherein the computer is configured to add the user identification code to each image file as meta-data.

15. The system of claim 10, wherein the display device is configured to store the images in a folder associated with the intended recipient.

16. The system of claim 10, wherein the display device is configured to detect physical proximity of an identification device of the intended recipient.

17. The system of claim 16, wherein the display device is configured to read a user identification code stored by the identification device.

18. The system of claim 17, wherein the user identification code is stored in a radio-frequency identification (RFID) tag of the identification device, and wherein the display device comprises an RFID tag reader that reads the user identification code from the RFID device.

19. A computer-readable medium comprising:
logic configured to automatically store images in association with an intended recipient;
logic configured to detect the physical proximity of the intended recipient to a display device; and
logic configured to, responsive to detecting the physical proximity of the intended recipient, display the images on the display device.

20. The computer-readable medium of claim 19, wherein the logic configured to detect the physical proximity of the intended recipient comprises logic configured to detect reading of a user identification code stored on an identification device of the intended recipient.
